(19) United States
(12) Patent Application Publication
(10) Pub. No.: US 2015/0201475 A1
(43) Pub. Date: Jul. 16, 2015

(54) Full color LED with data signal in parallel control

(71) Applicant: Shenzhen HuaCaiWei Technology Co., Ltd, Guangdong (CN)

(72) Inventor: Huaping YIN, Guangdong (CN)

(73) Assignee: Shenzhen HuaCaiWei Technology Co., Ltd, Guangdong (CN)

(21) Appl. No.: 14/254,910

(22) Filed: Apr. 17, 2014

(30) Foreign Application Priority Data
Jan. 15, 2014 (CN) 201420023319.1

(51) Int. Cl. H05B 33/08

(52) U.S. Cl. CPC H05B 33/0845

(57) ABSTRACT

A full color LED with data signal in parallel control, relate to full color LED. Full color LED with signal wire in parallel control, including one LED driven unit (1), one address storage unit (2), Trichromatic light-emitting diode chip (3); Trichromatic light-emitting diode chip (3) connects with LED driven unit (1) via data wire, address storage unit (2) connects with LED driven unit (1) via data wire. This utility model can make all the other LED work normally when any LED works abnormally.

### BACKGROUND OF THE INVENTION

This utility model relates to full color LED.

The prior art of LED with driven IC, adopting the drive control mode of signal in serial transmission control. Signal in this type transmission, if one LED has trouble with the signal transmission, then will make the LED beads behind this trouble LED all beyond control, thus will make a serious impact of looking like there being a large number bad LEDs.

### BRIEF SUMMARY OF THE INVENTION

This utility model aims to provide a full color LED with data signal in parallel control.

This utility model provides following technical scheme: A full color LED with data signal in parallel contra include one LED driven unit, one address storage unit, trichromatic light-emitting diode chip, trichromatic light-emitting diode chip connects with LED driven unit via data wire, address storage unit connects with LED driven unit via data wire.

Preferred, as described the trichromatic light-emitting diode chip includes one red light-emitting diode chip, one green light-emitting diode chip, one blue light-emitting diode chip.

Further, as described address storage unit store the LED's address data.

Furthermore, LED driven unit can change Red (R) light-emitting diode chip, Green (G) light-emitting diode chip, Blue (B) light-emitting diode chip's control terminal's pulse width (PWM) according to the input parallel data signal.

This utility model can make all the other LED work normally when any LED works abnormally;

### BRIEF DESCRIPTION OF THE DRAWINGS

FIG. 1 is the schematic diagram of this utility model's preferred embodiment.

### DETAILED DESCRIPTION OF THE INVENTION

Following is a further further explanation being combined with the drawings and embodiment of the utility model:

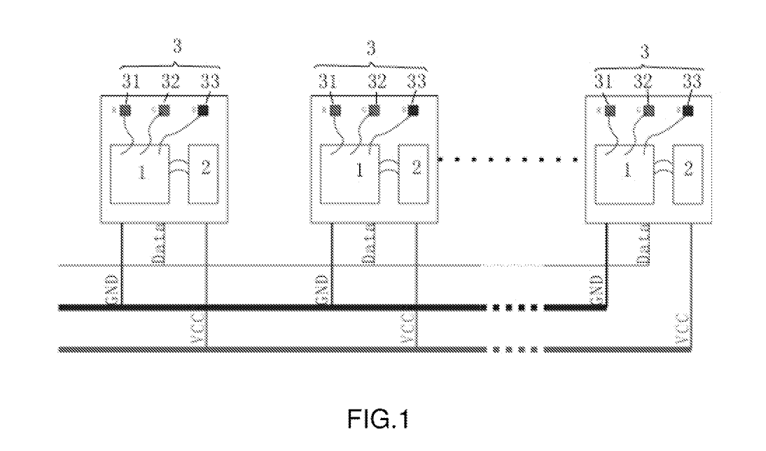

As depicted in FIG. 1, a full color LED with signal wire in parallel control, including one LED driven unit 1, one address storage unit 2, Trichromatic light-emitting diode chip 3; trichromatic light-emitting diode chip includes one red light-emitting diode chip 31, one green light-emitting diode chip 32, one blue light-emitting diode chip 33; Trichromatic light-emitting diode chip 3 connects with LED driven unit 1 via data wire, address storage unit 2 connects with LED driven unit 1 via data wire. LED driven unit 1 can write and read the address data for address storage unit 2, also can control trichromatic light-emitting diode chip via the parallel signal control bus data corresponding according to the address data.

LED driven unit drive trichromatic red light (R) light-emitting diode chip 31, green light (G) light-emitting diode chip 32, blue light (B) light-emitting diode chip 33's brightness adjustment. LED driven unit 1 can change the trichromatic light-emitting diode chip's control terminal's pulse width (PWM) according to the input parallel data signal, namely red light (R) light-emitting diode chip 31, green light (G) light-emitting diode chip 32, blue light (B) light-emitting diode chip 33's each control terminal's pulse width (PWM), thus achieving lighting control.

After each LED's address data being written in address storage unit 2, once power failure won't lose the address data, sit can be saved forever. Each LED has a relatively independent, it can be controlled via data signal independently addressable.

This utility model can make all the other LED work normally when any LED works abnormally, thus guarantee the stability and reliability of overall effect.

What is claimed is:

1. A full color LED with data signal in parallel control comprising one LED driven unit (1), one address storage unit (2), Trichromatic light-emitting diode chip (3); Trichromatic light-emitting diode chip (3) connects with LED driven unit (1) via data wire, address storage unit (2) connects with LED driven unit (1) via data wire.

2. The full color LED with data signal in parallel control as claimed in claim 1, wherein the Trichromatic light-emitting diode chip (3) including one red light-emitting diode chip (31), one green light-emitting diode chip (32), one blue light-emitting diode chip (33).

3. The full color LED with data signal in parallel control as claimed in claim 1, wherein the address storage unit (2) store the LED's address data.

4. The full color LED with data signal in parallel control as claimed in claim 1, wherein LED driven unit (1) can change Red (R) light-emitting diode chip (31)—Green (G) light-emitting diode chip (32), Blue (B) light-emitting diode chip (33)'s control terminals pulse width according to the input parallel data signal.
